(19) United States
(12) Patent Application Publication
(10) Pub. No.: US 2006/0098841 A1
(43) Pub. Date: May 11, 2006

(54) Method and system for enabling remote message composition

(76) Inventors: Pim Tuyls, Eindhoven (NL); Thomas Kevenaar, Eindhoven (NL); Geert Schrijen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,251

(22) PCT Filed: Mar. 1, 2004
(86) PCT No.: PCT/IB04/50170

§ 371 Date: Sep. 6, 2005

(30) Foreign Application Priority Data
Mar. 11, 2003 (EP) 03100606.7

(51) Int. Cl. G06K 9/00

(52) U.S. Cl. 382/100

(57) ABSTRACT

A method of and server (100) for enabling composition of a message at a remote terminal (101). The method comprises generating an image comprising a plurality of symbols representing input means, the symbols having an associated particular visual characteristic which is mutually different for at least two of the symbols, transmitting the image for display on the remote terminal (101), receiving a sequence of coordinates from the remote terminal (101), reconstructing the message as a sequence of input means represented by the symbols comprised in the image at the received coordinates, constructing an authentication code as a sequence of visual characteristics associated with the symbols comprised in the image at the received coordinates, and accepting the message as authentic if the authentication code matches a predetermined sequence of visual characteristics.

The invention relates to a method of enabling composition of a message at a remote terminal, comprising generating an image comprising a plurality of symbols representing input means, transmitting the image for display on the remote terminal, receiving a sequence of coordinates from the remote terminal, and reconstructing the message as a sequence of input means represented by the symbols comprised in the image at the received coordinates.

The invention further relates to a server and to a computer program product.

U.S. Pat. No. 6,209,102 discloses a way to allow composition of a message through visually rendered input means on a display of a remote terminal. A server generates an image so that it represents a plurality of input means such as keys on a keyboard. Each input means represents an element that can be used in the message that will be composed by the user.

At the remote terminal, the user then composes the message he wants to return by selecting the input means rendered as an image on the display. Selecting the input means is done by selecting a particular set of coordinates on the display of the terminal.

The set of coordinates is then transmitted back to the server. Eavesdropping software secretly installed on the remote terminal, or tapping into the return channel from terminal to server, cannot learn any passwords or sensitive information entered in this fashion. At the most, such software would be able to learn the particular sets of coordinates entered in this particular session. By randomizing the placement of the image means every time, the thusly learned information is of no use in future sessions.

When the server receives the set of coordinates, it translates it to a particular input means represented on the image. The message composed by the user is constructed as the elements represented by the particular input means to which the sets of coordinates were translated.

A problem with the system described above is that the server can not be sure that a response is really originating from the intended user. An adversary might for example randomly choose some random positions and send them back to the server. The server cannot distinguish such a response from invalid response by the intended honest user. In other words, there is no message authentication from terminal to server.

Furthermore, a ‘swap’ attack is possible. An adversary can generate a valid response by intercepting the set of coordinates transmitted to the server and simply swap the order of some of the coordinates. The server will not be able to detect this. This is particularly a problem when the message represents arbitrary input such as, for example, a bank account number or amount to be transferred or withdrawn from a particular bank account.

It is an object of the invention to provide a method according to the preamble, which protects against the ‘swap’ attack.

This object is achieved according to the invention in a method comprising generating an image comprising a plurality of symbols representing input means, the symbols having an associated particular visual characteristic which is mutually different for at least two of the symbols, transmitting the image for display on the remote terminal, receiving a sequence of coordinates from the remote terminal, reconstructing the message as a sequence of input means represented by the symbols comprised in the image at the received coordinates, constructing an authentication code as a sequence of visual characteristics associated with the symbols comprised in the image at the received coordinates, and accepting the message as authentic if the authentication code matches a predetermined sequence of visual characteristics.

Preferably the visual characteristic comprises the color or visual shape of the input means. The image transmitted to the terminal now contains, for example, two sets of alphanumeric characters, the characters in the fist set being in a first color and the characters in the second set being in a second color. The user can then compose his message by first picking a character from the first set and then picking a character from the second set. If an adversary subsequently reverses the order of the coordinates, the server can detect this tampering because the colors associated with the characters are in the wrong order.

Preferably the predetermined sequence is associated with a particular user of the remote terminal. The predetermined sequence of visual characteristics then serves as evidence that the message was indeed composed by that particular user. Alternatively a different, preferably randomly chosen, predetermined sequence could be used for every image, in which case the sequence should be indicated in the image.

Optionally an alarm is raised if the authentication code matches the predetermined sequence. This way a user operating under duress from an adversary can secretly raise the alarm. The message should still be accepted as authentic so the adversary won't notice the alarm has been raised. The user may be assigned two predetermined sequences, one for ‘normal’ operation and one for operation under duress.

Preferably an XOR operation is applied to the image using a key sequence associated with the user and the result of that operation is transmitted for display on the remote terminal. This enables the use of visual cryptography to securely send the image from the server to the terminal over an untrusted network. The result of the XOR operation can be displayed on an untrusted terminal as-is. The user superimposes a trusted decryption device on the terminal and thereby visually reconstructs the image. Visual cryptography and its application of enabling secure composition of messages is discussed in European patent application 02075527.8 (PHNL020121) and European patent application 02078660.4 (PHNL020804). In this setting it is preferred to use a new randomly chosen predetermined sequence in every image. This sequence must then be indicated in the transmitted image in some way (e.g. by indicating a sequence of colors that corresponds to the colors of the input means).

Preferably plural sequences of coordinates are received and plural respective messages and authentication codes are reconstructed, and the message is accepted as authentic if all respective messages are identical and all authentication codes match respective predetermined sequences of visual characteristics. This greatly reduces the probability that the adversary may be able to manipulate the set of coordinates in a way that still results in a valid message. When a single message has to be input by the user, it might be possible to identify two coordinate sets corresponding to input means having the same visual characteristic, for example because a total of only four different visual characteristics are used in the image.

These and other aspects of the invention will be apparent from and elucidated with reference to the embodiments shown in the drawings, in which:

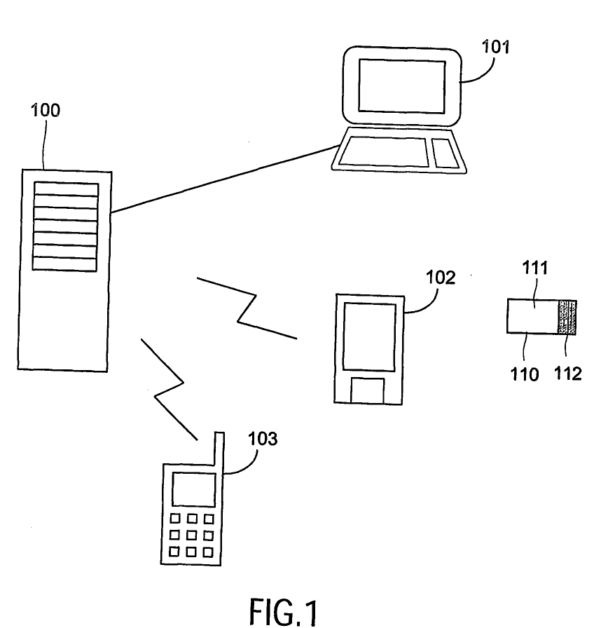

FIG. 1 schematically shows a system comprising a server and several terminals;

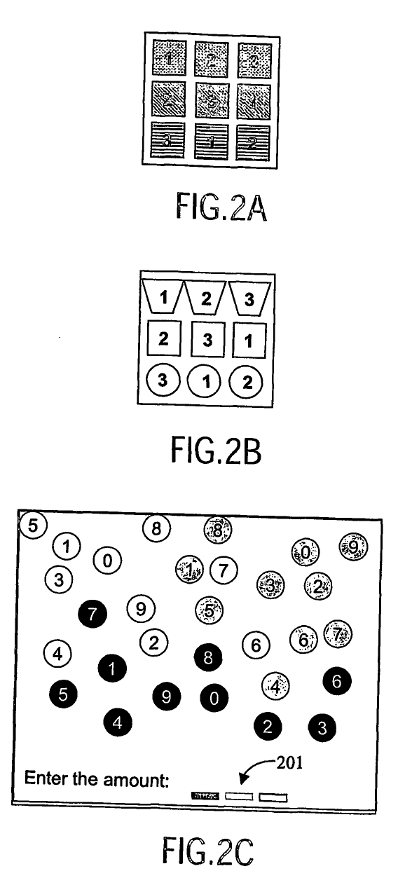

FIGS. 2A, 2B, 2C show example images that can be generated by the server;

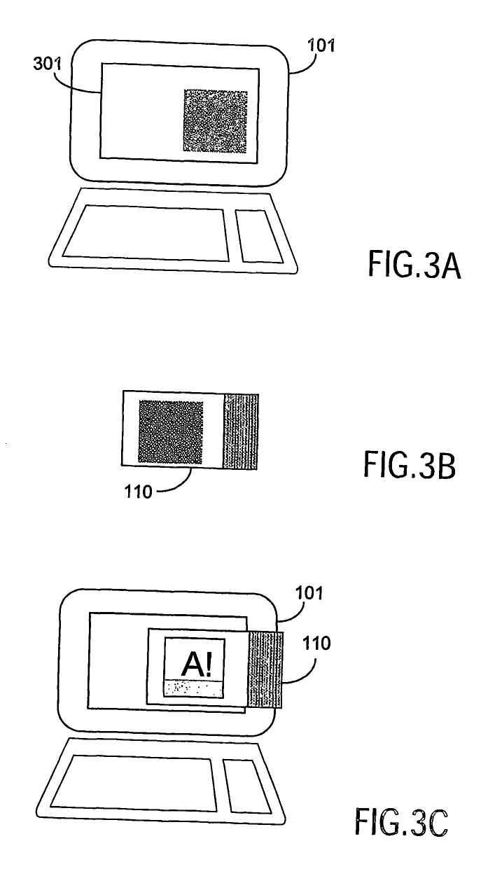

FIGS. 3A, 3B, 3C schematically illustrate an embodiment of the system using visual cryptography.

Throughout the figures, same reference numerals indicate similar or corresponding features. Some of the features indicated in the drawings are typically implemented in software, and as such represent software entities, such as software modules or objects.

FIG. 1 schematically shows a system according to the invention, comprising a server 100 and several terminals 101, 102, 103. While the terminals 101-103 are embodied here as a laptop computer 101, a palmtop computer 102 and a mobile phone 103, they can in fact be realized as any kind of device, as long as the device is able to interactively communicate with the server 100 and is able to render graphical images on a display. The communication can take place over a wire, such as is the case with the laptop 101, or wirelessly like with the palmtop computer 102 and the mobile phone 103. A network such as the Internet or a phone network could interconnect the server 100 and any of the terminals 101-103.

The server 100 generates an image representing a message that needs to be communicated to a user of the terminal 101. The image represents a plurality of input means such as keys on a keyboard. Such keys could be visually rendered as keys representing different alphanumerical characters, or as buttons representing choices like ‘Yes’, ‘No’, ‘More information’ and so on. Each input means represents an element that can be used in the message that will be composed by the user. Next to keys, the input means could also be checkboxes, selection lists, sliders or other elements typically used in user interfaces to facilitate user input. Other ways to visually represent input means are well known in the art.

It is observed that different input means may, but need not necessarily, represent different symbols. Providing multiple input means representing the same symbol has the advantage that a sequence of inputs made by the user can appear to be random even when the sequence contains repetitions. As used here, the term “symbol” can mean single alphanumerical characters, but also texts like ‘Yes’, ‘No’ and so on, as well as other linguistic or symbolic elements.

Some example images are shown in FIGS. 2A, 2B and 2C. The symbols all have an associated particular visual characteristic which is mutually different for at least two of the symbols. Preferably the visual characteristic comprises the color or visual shape of the input means. In FIGS. 2A, 2B and 2C the symbols are grouped in three groups, the symbols of one group sharing a visual characteristic and the visual characteristics of different groups being different. In FIG. 2A, the groups have different background patterns. In FIG. 2B, the groups have mutually different shapes.

In FIG. 2C, the groups have different colors (grayscale values). The symbols representing the input means are now also distributed in a (pseudo-)random fashion over the image. This way their location cannot be guessed easily by an adversary wishing to manipulate the response. Further, in FIG. 2C there is also an indication 201 of the order in which the input means should be selected.

Returning to FIG. 1, the server 100 transmits the generated image to the terminal 101 for display thereon. The user then composes the message he wishes to transmit to the server 100 by selecting keys or other input means rendered as an image on the display.

Selecting the input means is done by selecting a particular set of coordinates on the display of the terminal 101. Preferably, the user inputs the set of coordinates by applying pressure to a particular spot of the display, the set of coordinates corresponding to the particular spot The display, equipped with a touch-sensitive screen, can then register the spot to which pressure was applied, and translate this to a set of coordinates. Of course, other input devices such as a mouse, a graphics tablet or even a keyboard can also be used.

The set of coordinates is then transmitted back to the server 100. When the server 100 receives the set of coordinates, it translates it to a particular input means represented on the image. The message composed by the user is constructed as the elements represented by the particular input means to which the sets of coordinates were translated. For example, using the image of FIG. 2C, the outcome could be 7-3-1 or 4-9-1. Random coordinates generated by an adversary will generally not correspond to input means, and so such a message can be distinguished easily from valid messages.

To establish whether the constructed message is authentic, the server 100 next constructs an authentication code. The server 100 now constructs a sequence of visual characteristics associated with the symbols comprised in the original image at the received coordinates. For example, using the image of FIG. 2C, the outcome could be black-gray-white or gray-gray-white. In the case of FIG. 2B, the outcome could be square-circle-trapezoid. The server 100 accepts the message as authentic if the authentication code matches a predetermined sequence of visual characteristics.

The predetermined sequence can be unique to the image, as is the case in FIG. 2C, where indication 201 serves to inform the user that he must compose his message by first using a black input symbol, then a grayscale symbol and finally a white symbol. The outcome 7-3-1 would now be accepted as authentic only if the black ‘7’ symbol, the gray ‘3’ symbol and the white ‘1’ symbol were selected by the user in that order.

Alternatively the predetermined sequence can be associated with the user. For example, the server 100 could maintain a list of users and sequences they are supposed to use. One user might be assigned “square-circle-trapezoid” and another one “circle-trapezoid-square”. Both users could use the image of FIG. 2b.

One user could also be assigned two predetermined sequences, one of which is supposed to be used only when the user is operating the terminal 101 under duress. In that case, the server 100 can trigger an alarm (not shown). Both sequences are accepted as authentic, to prevent an adversary from learning the alarm has been raised.

Let c be defined as the area of the appropriate color (of the next number that has to be entered) and A as the total display area. The probability Pₛ of performing a successful substitution attack now becomes proportional to

$$\frac{c}{A}$$

per symbol (with a proportionality factor smaller than 1). In order to further reduce this probability, the user can be asked to type in his message k times (k>1) with different predetermined sequences used each time. In this case the probability becomes proportional to

$${( \frac{c}{A} )}^{k}$$

To further increase the security of the system, in a preferred embodiment the server 100 encodes the image as a sequence of information units based on visual cryptography. This is preferably done by applying an XOR operation to every pixel in the image using a key sequence associated with the user of the terminal 101. The result is transmitted to the terminal 101 instead of the image itself. Visual cryptography and its application of enabling secure composition of messages is discussed in European patent application 02075527.8 (PHNL020121) and European patent application 02078660.4 (PHNL020804). These applications discuss visual cryptography using liquid crystal displays (LCDs) to display the encoded image and the key sequence. ‘Classical’ visual cryptography uses transparent sheets and requires mapping every pixel to a block of pixels, preferably 2×2 or 2×1 pixels, when encoding it This is also discussed in the two aforementioned European patent applications.

Using visual cryptography means that it is no longer necessary to protect the transmission by e.g. encrypting the encoded sequence or setting up a secure authenticated channel, before transmitting it. Assuming the key sequence is not available and chosen carefully, it is impossible for an eavesdropper to recover the image by using only the encoded sequence. Decryption of the visually encoded image will now be discussed in more detail.

Also shown in FIG. 1 is a personal decryption device 110. This device 110 is personal to a user and should be guarded well, as it is to be used to decrypt visually encoded messages sent by the server 100 to any of the terminals 101-103. Anyone who gains physical control over the decryption device 110 can read all visually encrypted messages intended for the user. To add some extra security, entering a password or Personal Identification Number (PIN) could be required upon activation of the decryption device 110. The device 110 could also be provided with a fingerprint reader, or be equipped to recognize a voice command uttered by its rightful owner.

The decryption device 110 comprises a display 111 and a storage area 112. The display 111 is preferably realized as an LCD screen. Although normally such a display 111 would have a polarization filter on both sides of the liquid crystal layer, in this embodiment the display 111 only has one polarization filter. The LCD screen of the terminal 101 that receives the visually encrypted message should then have a portion of the topmost polarization filter removed. This portion should be large enough to allow the display 111 to be superimposed upon it. Alternatively, the LCD screen of the terminal 101 can be provided with a (preferably small) separate display on which the display 111 is to be superimposed. In another embodiment the display 111 has no polarization filter.

The storage area 112 comprises the key sequence to be used in decrypting visually encrypted images. Elements of the key sequence represent arbitrary rotations of the polarization of cells in the display 111.

When the terminal 101 receives the encoded sequence, it displays the elements of the sequence as respective pixels on a portion of an LCD screen 301, as illustrated in FIG. 3A. The encoded sequence is displayed by rotating the polarization of respective cells in the liquid crystal layer in the display 301 by an amount indicated by respective elements in the encoded sequence.

The user then activates his decryption device 110 in FIG. 3B. This causes the decryption device 110 to output a graphical representation on the display 111 in dependence on the key sequence stored in storage area 112. In FIG. 3C, the user superimposes the personal decryption device 110 upon the pixels displayed on display 301. Because both the decryption device 110 and the terminal 101 each effectively display one share of a visually encrypted image, the user can now observe the reconstructed image. In the example of FIG. 3C, the reconstructed message is the textual message “A!” in black lettering with a grayscale bar below.

Because neither the terminal 101 nor the personal decryption device 110 at any time has sufficient information to reconstruct the image itself, the contents of the image cannot be recovered by a malicious application running on either device. Further, since the personal decryption device 110 does not have any communication means, it is impossible to obtain the key sequence from the storage area 112 without gaining physical access to the decryption device 110.

It should be noted that the above-mentioned embodiments illustrate rather than limit the invention, and that those skilled in the art will be able to design many alternative embodiments without departing from the scope of the appended claims. For example, it is not necessary to use visual cryptography. The image can also be encrypted using conventional secret key and/or public key encryption algorithms. It can be sent unencrypted over a secure channel, i.e. one that an attacker cannot tap into.

The invention can be used in any kind of system in which a secure communication from a server to a terminal and/or vice versa is necessary. The remote terminals 101-105 can be embodied as personal computers, laptops, mobile phones, palmtop computers, automated teller machines, public Internet access terminals and so on.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of enabling composition of a message at a remote terminal (101), comprising
generating an image comprising a plurality of symbols representing input means, the symbols having an associated particular visual characteristic which is mutually different for at least two of the symbols,
transmitting the image for display on the remote terminal (101),
receiving a sequence of coordinates from the remote terminal (101),
reconstructing the message as a sequence of input means represented by the symbols comprised in the image at the received coordinates,
constructing an authentication code as a sequence of visual characteristics associated with the symbols comprised in the image at the received coordinates,
and accepting the message as authentic if the authentication code matches a predetermined sequence of visual characteristics.

2. The method of claim 1, in which the visual characteristic comprises the color of a symbol.

3. The method of claim 1, in which the visual characteristic comprises the shape of a symbol.

4. The method of claim 1, in which the order of the visual characteristics in the predetermined sequence is chosen (pseudo)randomly and an indication of the order is incorporated in the image.

5. The method of claim 1, in which the predetermined sequence is associated with a particular user of the remote terminal (101).

6. The method of claim 5, in which an alarm is raised if the authentication code matches the predetermined sequence.

7. The method of claim 4, in which an XOR operation is applied to the image using a key sequence associated with the user and the result of that operation is transmitted for display on the remote terminal (101).

8. The method of claim 1, in which the symbols in the image are distributed in a (pseudo-)random fashion.

9. The method of claim 1, in which plural sequences of coordinates are received and plural respective messages and authentication codes are reconstructed, and the message is accepted as authentic if all respective messages are identical and all authentication codes match respective predetermined sequences of visual characteristics.

10. A server (100) for enabling composition of a message at a remote terminal (101), comprising image generating means for generating an image comprising a plurality of symbols representing input means, the symbols having an associated particular visual characteristic which is mutually different for at least two of the symbols, transmitting means for transmitting the image for display on the remote terminal (101), receiving means for receiving a sequence of coordinates from remote terminal (101), message reconstructing means for reconstructing the message as a sequence of input means represented by the symbols comprised in the image at the received coordinates, and authenticating means for constructing an authentication code as a sequence of visual characteristics associated with the symbols comprised in the image at the received coordinates and accepting the message as authentic if the authentication code matches a predetermined sequence of visual characteristics.

11. A computer program product arranged for causing a processor to execute the method of claim 1.
